(19) United States
(12) Patent Application Publication
(10) Pub. No.: US 2019/0023621 A1
(43) Pub. Date: Jan. 24, 2019

(54) Coating System For A Turbine Component

(71) Applicant: Siemens Aktiengesellschaft, Muenchen (DE)

(72) Inventors: Gia Khanh Pham, Neubiberg (DE); Niels Van der Laag, Muenchen (DE)

(73) Assignee: Siemens Aktiengesellschaft, Muenchen (DE)

(21) Appl. No.: 16/069,468

(22) PCT Filed: Jan. 11, 2017
(86) PCT No.: PCT/EP2017/050496

§ 371 Date: Jul. 11, 2018

(30) Foreign Application Priority Data
Jan. 13, 2016 (DE) 10 2016 200 294.5

(51) Int. Cl. C04B 41/00; C04B 41/50; C04B 41/87; F01D 5/28

(52) U.S. Cl. CPC C04B 41/009; C04B 41/5031; C04B 41/5042; F05D 2300/611; F01D 5/282; F01D 5/288; F05D 2300/6033; C04B 41/87

(57) ABSTRACT

Some examples include a turbine component comprising: a ceramic composite (CMC) having a matrix; and a watertight coating chemically miscible and/or mutually soluble with/in the CMC because particles and/or fibers which are composed of an identical or chemically matching, but at least chemically compatible. At least part of the watertight coating is incorporated in the matrix of the CMC, the matching and compatible material comprising at least one of: aluminum oxide, yttrium aluminum garnet (YAG), and yttrium-stabilized zirconium oxide (YSZ).

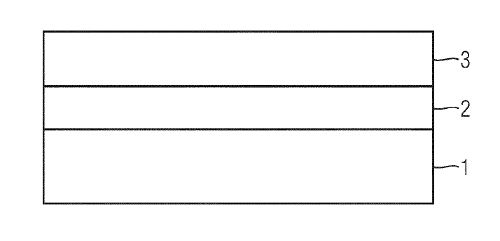

### CROSS-REFERENCE TO RELATED APPLICATIONS

This application is a U.S. National Stage Application of International Application No. PCT/EP2017/050496 filed Jan. 11, 2017, which designates the United States of America, and claims priority to DE Application No. 10 2016 200 294.5 filed Jan. 13, 2016, the contents of which are hereby incorporated by reference in their entirety.

### TECHNICAL FIELD

The present disclosure relates to turbines. Various embodiments may include a part of a thermal barrier layer of an environmental barrier coating system (environmental barrier coatings (EBC)) for a turbine component, for example a gas turbine blade and/or a gas turbine vane, which is composed at least partly of a ceramic matrix composite material “CMC” (ceramic matrix composite).

### BACKGROUND

Thermal barrier layers are used in the industry to lower the material temperature in high-temperature applications. One example is gas turbines, in the case of which the coating is applied according to requirements in the range from a few tenths of a millimeter up to millimeters to the blades and to other components in the hot gas path of turbines.

Turbines are, for example in the form of gas turbines, used for generating electric energy by means of combustion gas in a combustion chamber. Here, the hot gas flows into the turbine which is connected to a generator. To increase the efficiency of the gas turbine, the gas is introduced at as high a temperature as possible. The hotter the gas, the higher the demands made of the coating materials which protect the turbine components, for example turbine vanes and turbine blades, along the hot gas path in the turbines against damage by the hot gas.

Turbine components of this type have hitherto been made up of a superalloy having a bonding layer and, applied thereto, a thermal barrier coating (TBC), with these two layers not only restricting the gas temperature but also requiring a cooling system. An alternative procedure is the development of ceramic composite materials, known as ceramic matrix composites “CMCs”. These support structures withstand higher temperatures than superalloys and have a lower density and a better oxidation resistance, in particular oxidic CMCs. The limited fracture strength and damage tolerance of the ceramic materials is in principle improved and compensated for by fiber reinforcement.

The CMCs are nevertheless susceptible to constituents of the hot gas, for example water vapor, in a manner comparable to the conventional superalloys. For this reason, the CMC support structures are guarded against environmental influences by means of a bonding layer and, on top of this, at least one to two protective layers, which are in their entirety referred to as environmental barrier coatings (EBC). Typical EBC systems for, for example, silicon carbide SiC/SiC-CMCs are barium-strontium-aluminum silicates (BSAS) or silicates of rare earths, i.e. yttrium, ytterbium, e.g. Y₂Si₂O₇, Y₂SiO₅, in the form of a mixed mullite-BSAS coating on a silicon bonding layer.

In addition, a separate barrier layer against the intrusion of liquid CMAS, i.e. calcium, magnesium, aluminum silicates, can be provided on the EBC system as per the prior art known from, for example, WO 2010/080240 and/or from US 2010/0158680. A combined protective layer against moisture, oxygen and intrusion of calcium, magnesium and/or aluminum silicates (CMAS) into a support structure composed of ceramic matrix material for high-temperature applications is known from DE 10 2015 205 807.7. This protective layer comprises a ceramic component, a spinel of the general formula (Mg, Zn, Fe, Mn)—Al₂O₄, a perovskite of the general formula (RE1, RE2)AlO₃, where RE1 is a trivalent cation of a rare earth element and can be the same as or different from RE2, an oxyapatite and/or a garnet having the general formula (RE1RE2RE3)Al₅O₁₂, where RE1, RE2 and RE3 are each a trivalent cation of a rare earth element and can be identical or different, and also any mixtures of the abovementioned compounds.

### SUMMARY

A disadvantage of the prior art is that the coating system comprises too many layers, with adhesion problems at the interfaces and in particular also differences in the coefficients of thermal expansion being able to lead to instabilities in the coating systems for turbine components such as gas turbine blades and/or gas turbine vanes. The present disclosure describes various coating systems for turbine components, in particular gas turbine blades and/or gas turbine vanes, which minimize or overcome the disadvantages of the prior art.

For example, some embodiments include a coating for a turbine component, in particular gas turbine component, for example a turbine blade, which is composed at least partly of a ceramic composite (CMC), wherein the part which is composed of a ceramic composite has a coating which is watertight and is chemically miscible and/or mutually soluble with/in the material of the turbine component, in particular having unlimited chemical miscibility and/or unlimited mutual solubility, i.e. the materials are “chemically compatible”, because particles and/or fibers which are composed of an identical or chemically matching, but at least chemically compatible, material as is present in the watertight coating are incorporated in the matrix of the CMC of the gas turbine blade, with this matching and compatible material being, in particular, based on aluminum oxide, yttrium aluminum garnet (YAG) and/or yttrium-stabilized zirconium oxide (YSZ) or any mixtures of these components.

In some embodiments, particles having an average size in the micron range are present in the watertight coating.

In some embodiments, a matrix composed of a sintered ceramic is present in the watertight coating.

In some embodiments, the density of the watertight coating is greater than 90%.

In some embodiments, the weight of the coating is greater than or equal to 90% of the theoretical weight of the coating.

In some embodiments, the watertight coating does not have any closed pores.

In some embodiments, the watertight coating does not have any open pores.

### BRIEF DESCRIPTION OF THE DRAWINGS

The teachings herein are illustrated below with the aid of a FIGURE which showing an illustrative structure of a coating system according to a working embodiment.

### DETAILED DESCRIPTION

Some embodiments include a coating for a turbine component, in particular gas turbine component, for example a turbine blade, which is composed at least partly of a ceramic composite (CMC), wherein the part which is composed of a ceramic composite has a coating which is watertight and is chemically miscible and/or mutually soluble with/in the material of the turbine component, in particular having unlimited chemical miscibility and/or unlimited mutual solubility, i.e. the materials are “chemically compatible”, because particles and/or fibers which are composed of an identical or chemically matching, but at least chemically compatible, material as is present in the watertight coating are incorporated in the matrix of the CMC of the gas turbine blade, with this matching and compatible material being, in particular, based on aluminum oxide, yttrium aluminum garnet (YAG) and/or yttrium-stabilized zirconium oxide (YSZ) or any mixtures of these components.

The term chemically compatible material is used to refer to, in particular, a material which has a matching empirical chemical formula. The modification, in particular the crystallographic modification, in which the chemically matching material is present can be completely different, so that an amorphous material or ceramically sintered material is “chemically compatible” with a crystalline or partially crystalline material for the purposes of the present invention, i.e. the materials are chemically miscible with one another without appreciable reaction such as conversion or decomposition.

Some embodiments include a coating having a very dense microstructure, the weight of which is more than 90% of the theoretical weight thereof, so that a virtually pore-free material which displays a high protective action, for example on a turbine blade, is present in the coating. In some embodiments, the latter is virtually pore-free, i.e. the coating has a density which results in a weight of the coating which is greater than or equal to 95% of theoretical weight, i.e. at 100% density, and is theoretically free of pores.

In some embodiments, the fillers in the CMC can be present in one or more different fractions, with there being able to be differences in the particle size of from a number of microns to nanometers. In some embodiments, there can be differences in the particle composition of the filler or fillers, for example starting out from a filler composed of pure Y₃Al₁₅O₁₂ (YAG) through a 50:50 mol % mixture with a stabilized zirconium (IV) oxide, for example YSZ, to pure zirconium (IV) oxide, e.g., stabilized with from 4 mol % to 8 mol % of yttrium oxide Y₂O₃.

In some embodiments, the fillers are not amorphous but instead polycrystalline, partially crystalline and/or crystalline in both the matrix and the CMC.

In some embodiments, the particle size of the at least partially crystalline particles of the filler or fillers referred to as “coarse” in the following is, for example, in the range from 500 nm to 15 μm, with a great abundance of suitable particles being present in the particle size range from 700 nm to 3 μm. The fine particles sinter to form a solid material having a ceramic microstructure during production of a coating.

In some embodiments, the fillers can be present in various shapes, namely spherical, platelet-like and/or rod-like.

In some embodiments, the coating system of the turbine component such as the gas turbine blade and/or the gas turbine vane is produced together with the gas turbine and/or the gas turbine vane. However, coating of a previously manufactured gas turbine vane or gas turbine blade can equally well be carried out, i.e., for example, retrofitting can be carried out.

In the following, the invention will be illustrated with the aid of some examples:

In some embodiments, a very dense YAG- and/or YSZ-based coating according to the invention is produced by application of a slip and subsequent heat treatment. For example, the slip is produced by stirring or mixing coarse particles, for example particles in the micron range, and/or fine filler particles in the nanometer or submicron range with deionized, distilled water. For example, the ratio of fillers to water can be 50:50, with any other ratios being equally well able to be used.

In some embodiments, in the finished mixture, solid filler is present in the range from 10 to 60% by volume in an aqueous solution. In some embodiments, the proportion of filler is in the range from 20 to 50% by volume and/or in the range from about 30 to 40% by volume of filler, for example, particles of Al₂O₃, YAG and/or YSZ, again by way of example in various particle fractions. A binder or a binder mixture, a dispersant and/or a sintering aid can optionally also be mixed in; these components are well known to a person skilled in the art and both the material and the amount can easily be determined by such a person so as to fit the respective system. For example, an organic fluidizer, in particular an organic alkali-free fluidizer such as a carboxylic acid preparation, can be used as dispersant.

In some embodiments, the material for the coating is applied as water-containing and/or acid-containing slip to the CMC substrate and subjected together with the latter to a heat treatment. Here, temperatures up to 1100° C. can be realized. This forms a coating composed of a sintered material in which filler particles, for example in the micron size range, are present. A strong bond produced in this way between dense watertight coating and turbine component such as gas turbine vane and/or gas turbine blade can, for example, be characterized by optical methods such as scanning electron micrographs, with the substrate, for example the gas turbine vane, being able to be seen as a layer containing fibers and the coating being able to be seen as a layer without fibers and with filler particles. The scanning electron micrographs can also be combined with chemical analyses for the purpose of characterization.

In some embodiments, the CMC material of the gas turbine blade and/or the gas turbine vane comprises stabilizing fibers which are composed of the same material as the coarse or fine fillers of the coating, for example of Al₂O₃, YAG and/or YSZ. The CMC substrate material and the coating material can then, for example, be distinguished analytically by fibers and optionally also particles being present in the substrate material and particles of the same oxide or the same oxide mixture but no fibers being present in the coating.

In some embodiments, the fibers can, for example, be based on aluminum oxide and/or mullite and have at least proportions of amorphous material. The slip is applied to the substrate by conventional methods, for example by spraying, dipping, brushing-on or the like. The coating is obtained by sintering and heat treatment of the gas turbine blade or gas turbine vane coated with slip. Here, the fine filler particles sinter and give a virtually pore-free ceramic coating, while the larger and coarser particles provide the strength and resistance of the coating.

In some embodiments, the substrate 1, for example, a substrate composed of a CMC, is at the bottom. A CMC comprises a matrix of, for example, an oxidic or nonoxidic ceramic such as SiC, Si₃N₄, SiO₂, Al₂O₃ or any mixtures thereof, for example the CMC matrices known from EP 1394138. Fibers which, in particular, serve for reinforcement are then present in the matrix. In some embodiments, filler particles can also be incorporated in the matrix. The contents of EP 1394138 are hereby incorporated by reference into the present disclosure insofar as they concern CMC substrates. Fibers and optionally also particles are incorporated into this matrix composed of the abovementioned materials in order to increase the strength in the CMC. The fibers are, for example, composed of the same material as the fillers of the slip from which the water vapor-impermeable coating 2 present on the substrate has been made.

In some embodiments, a substrate such as a gas turbine vane composed of a matrix having fiber filling, with the matrix and the fibers optionally being composed of the same chemical material, for example aluminum oxide, is described in the present case. A coating which can be produced via a slip is present on this substrate, with the coating once again comprising the same material but in the form of a sintered ceramic having coarse filler particles, for example in the micron range.

In some embodiments, this coating can be produced by heating and sintering a slip on the CMC substrate, with the slip comprising at least one fraction of a finer filler and a fraction of a coarser filler and a sintered ceramic being formed from the finer filler particles by sintering and the coarser particles still remaining detectable in the finished coating. The chemically compatible watertight barrier layer 2, which comprises filler particles comprising, in a preferred embodiment, the same material as filler particles present in the CMC substrate, is located on the substrate 1. The bonding of the watertight virtually pore-free coating 2 to the substrate is excellent because of the chemical compatibility and because no genuine interfaces which have to be joined are formed, but instead the interfaces go over into one another and form boundary regions.

In some embodiments, a thermal barrier coating TBC 3, which can be applied by conventional methods, may be present on the watertight coating 2. The thickness of the layer is, for example, in the micron range from about 500 nm to 10 mm.

In some embodiments, a coating system for a turbine component such as a gas turbine blade and/or a gas turbine vane, in particular a component composed of a ceramic matrix composite material “CMC” (ceramic matrix composite), includes a water vapor-impermeable ceramic coating which is chemically compatible with the substrate material and is virtually pore-free being provided on the CMC substrate.

What is claimed is:

1. A turbine component comprising:
a ceramic composite (CMC) having a matrix;
a watertight coating chemically miscible and/or mutually soluble with/in the CMC because particles and/or fibers which are composed of an identical or chemically matching, but at least chemically compatible;
wherein at least part of the watertight coating is incorporated in the matrix of the CMC, the matching and compatible material comprising at least one of: aluminum oxide, yttrium aluminum garnet (YAG), and yttrium-stabilized zirconium oxide (YSZ).

2. The turbine component as claimed in claim 1, wherein the watertight coating comprises particles having an average size in the micron range.

3. The turbine component as claimed in claim 1, wherein the watertight coating comprises a matrix composed of a sintered ceramic.

4. The turbine component as claimed in claim 1, wherein the watertight coating has a density of greater than 90%.

5. The turbine component as claimed in claim 1, wherein the watertight coating has a weight greater than or equal to 90% of the theoretical weight of the coating.

6. The turbine component as claimed in claim 1, wherein the watertight coating does not have any closed pores.

7. The turbine component as claimed in claim 1, wherein the watertight coating does not have any open pores.
